(19) United States
(12) Patent Application Publication
(10) Pub. No.: US 2013/0213247 A1
(43) Pub. Date: Aug. 22, 2013

(54) STENCIL APPARATUS FOR PRINTING SOLDER PASTE

(71) Applicants: Yong Won LEE, Suwon-si (KR); Ji Young Jang, Incheon (KR); Young Jun Moon, Hwaseong-si (KR); Soon Min Hong, Seoul (KR)

(72) Inventors: Yong Won LEE, Suwon-si (KR); Ji Young Jang, Incheon (KR); Young Jun Moon, Hwaseong-si (KR); Soon Min Hong, Seoul (KR)

(73) Assignee: SAMSUNG ELECTRONICS CO., LTD., Suwon-si (KR)

(21) Appl. No.: 13/399,176

(22) Filed: Feb. 17, 2012

(51) Int. Cl. B05C 17/04; B05D 3/12; B05D 3/10

(52) U.S. Cl. 101/123; 427/299; 427/307; 427/290

(57) ABSTRACT

A solder paste printing stencil apparatus for printing a solder paste on a printed circuit board includes a plate-shaped stencil mask made of fine stainless steel grains to suppress a phenomenon in which the solder paste adheres to the stencil mask.

### BACKGROUND

1. Field

The following description relates to a solder paste printing stencil apparatus for printing a solder paste on a printed circuit board.

2. Description of the Related Art

A solder paste printing stencil apparatus is adapted to print a solder paste on a printed circuit board.

Such a solder paste printing stencil apparatus includes a plate-shaped stencil mask provided with an opening at a position corresponding to a pad formed on a printed circuit board, and a squeegee to move a solder paste along an upper surface of the stencil mask.

As the solder paste is moved along the upper surface of the stencil mask by the squeegee when the stencil mask is laid on a printed circuit board, the solder paste is transferred to the pad through the opening provided by the stencil mask. Thus, printing of the solder paste on the printed circuit board is achieved.

### SUMMARY

Therefore, it is an aspect to provide a solder paste printing stencil apparatus capable of suppressing a phenomenon in which the solder paste easily adheres to the stencil mask.

Additional aspects of the invention will be set forth in part in the description which follows and, in part, will be obvious from the description, or may be learned by practice of the invention.

In accordance with one aspect, a solder paste printing stencil apparatus includes a stencil mask having a plate shape, wherein the stencil mask may be made of fine stainless steel grains.

The fine stainless steel grains may have a grain size of 5 μm or less.

The solder paste printing stencil apparatus may further include a coating layer to suppress a phenomenon in which a solder paste adheres to the stencil mask.

The coating layer may include a diamond-like carbon film.

The solder paste printing stencil apparatus may further include an opening formed through the stencil mask to coat the solder paste on a printed circuit board. The coating layer may include a first coating layer formed on an inner surface of the opening.

The coating layer may include a second coating layer formed on a first surface of the stencil mask to contact a printed circuit board, on which the solder paste is coated.

The solder paste printing stencil apparatus may further include a squeegee to move the solder paste on a second surface of the stencil mask opposing the first surface of the stencil mask to contact a printed circuit board, on which the solder paste is coated. The coating layer may include a third coating layer formed on an outer surface of the squeegee.

Since the stencil mask is made of fine stainless steel grains, as described above, it may be possible to suppress a phenomenon in which the solder paste, which has a greater grain size than the stencil mask, adheres to the stencil mask.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic sectional view illustrating a solder paste printing stencil apparatus according to an exemplary embodiment;

FIG. 2 is a schematic sectional view illustrating a solder paste printing stencil apparatus according to another exemplary embodiment; and

FIG. 3 is a schematic sectional view illustrating a solder paste printing stencil apparatus according to another exemplary embodiment.

### DETAILED DESCRIPTION

Reference will now be made in detail to the embodiments, examples of which are illustrated in the accompanying drawings, wherein like reference numerals refer to like elements throughout. The embodiments are described below to explain the present invention by referring to the figures.

Hereinafter, embodiments will be described with reference to the accompanying drawings.

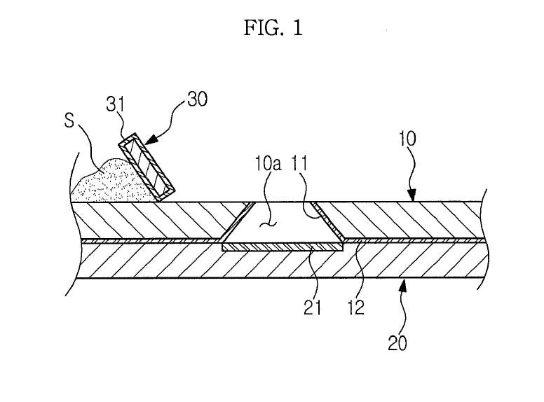

Referring to FIG. 1, a solder paste printing stencil apparatus according to an exemplary embodiment is illustrated. The solder paste printing stencil apparatus is adapted to print a solder paste S on a printed circuit board 20.

The printed circuit board 20 includes a pad 21 made of metal, to provide an electrical connection to electronic elements mounted on the printed circuit board 20, or, in other words, to function as an electrode. The solder paste printing stencil apparatus includes a stencil mask 10 formed to have a plate shape and provided with an opening 10a at a position corresponding to the pad 21 of the printed circuit board 20, and a squeegee 30 to move a solder paste S along a surface of the stencil mask 10, thereby transferring the solder paste S to the pad 21 through the opening 10a.

The stencil mask 10 may made of fine stainless steel grains having a grain size from approximately 1 μm to approximately 2 μm. When the stencil mask 10 is made of such fine stainless steel grains, it may be possible to suppress a phenomenon in which the solder paste S adheres to the stencil mask 10. This is due to the difference between the grain size of the solder paste S and the grain size of the fine stainless steel grains forming the stencil mask 10 because the grain size of the solder paste S is from approximately 20 μm to approximately 40 μm.

Also, it may be possible to suppress the solder paste S from adhering to a second surface of the stencil mask 10 during a procedure in which the solder paste S is moved along the second surface of the stencil mask 10 by the squeegee 30. Accordingly, the amount of the solder paste S used in a printing procedure may be reduced.

The solder paste printing stencil apparatus according to the illustrated embodiment may further include coating layers 11, 12, and 31 in order to further suppress the adhering phenomenon of the solder paste S.

That is, the solder paste printing stencil apparatus includes a first coating layer 11 formed on an inner surface of the opening 10a, a second coating layer 12 formed on a first surface of the stencil mask 10 contacting the printed circuit board 20 (a lower surface of the stencil mask 10 in FIG. 1), and a third coating layer 31 formed on an outer surface of the squeegee 30. In an exemplary embodiment, the coating layers 11, 12, and 31 are formed of a diamond-like carbon film.

The first coating layer 11 performs a function of suppressing the solder paste S printed on the pad 21 through the opening 10a from adhering to the inner surface of the opening 10a. The second coating layer 12 performs a function of suppressing the first surface of the stencil mask 10 from adhering to the printed circuit board 20 via the solder paste S, thereby enabling the stencil mask 10 to be easily separated from the printed circuit board 20. The third coating layer 31 performs a function of suppressing the solder paste S from adhering to the squeegee 30, thereby enabling the squeegee 30 to be easily separated from the stencil mask 10.

The stencil mask 10 may be manufactured as follows. First, a body of the stencil mask 10 is formed to have a plate shape, using fine stainless steel grains. Thereafter, the opening 10a is formed through the body of the stencil mask 10. Subsequently, the stencil mask 10 is subjected to a sanding process and an electrolytic polishing process in a sequential manner, to polish the first surface of the stencil mask 10 to contact the printed circuit board 20 and the inner surface of the opening 10a provided at the stencil mask 10, to decrease the surface roughness. After completion of the sanding process and electrolytic polishing process, the first coating layer 11 and second coating layer 12 are formed on the first surface of the stencil mask 10 and the inner surface of the opening 10a provided at the stencil mask 10, respectively, by a diamond-like carbon (DLC) film formation process. Thus, the manufacture of the stencil mask 10 is completed.

The squeegee 30 is manufactured by forming a body of the squeegee 30 to have a plate shape, using fine stainless steel grains, similarly to the stencil mask 10, and then forming the third coating layer 31 over an outer surface of the body of the squeegee 30, using a DLC film formation process.

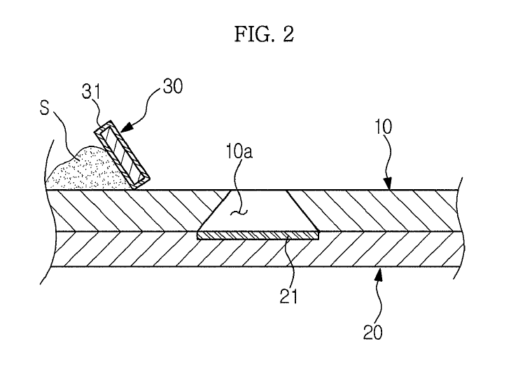

Although the solder paste printing stencil apparatus according to the illustrated embodiment includes all the coating layers 11, 12, and 31, namely, the first coating layer 11 formed at the opening of the stencil mask 10, the second coating layer 12 formed on the first surface (upper surface) of the stencil mask 10, and the third coating layer 31 formed on the squeegee 30, the solder paste printing stencil apparatus is not limited thereto. In a solder paste printing stencil apparatus according to another embodiment illustrated in FIG. 2, the first coating layer 11 and second coating layer 12 of FIG. 1 are not used, and only the third coating layer 31 of the squeegee 30 is provided.

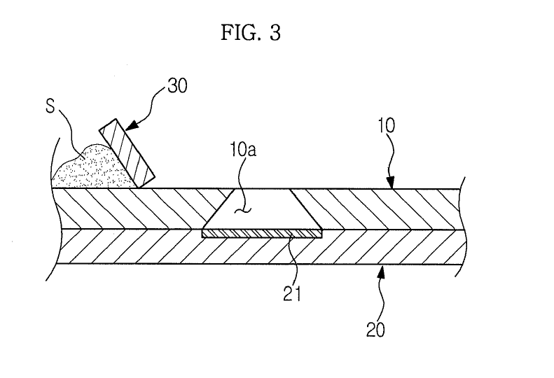

In another embodiment illustrated in FIG. 3, all the coating layers 11, 12, and 31 of FIG. 1 may not be used. In this case, the solder paste printing stencil apparatus may be made of fine stainless steel grains having a grain size from approximately 1 μm to approximately 2 μm.

That is, the first coating layer 11, second coating layer 12, and third coating layer 31 may be selectively applied in accordance with a desire of the designer.

Although the fine stainless steel grains have a grain size from approximately 1 μm to approximately 2 μm in the above-described embodiment, they are not limited thereto. Even when the fine stainless steel grains have a grain size of approximately 5 μm, it may be possible to sufficiently suppress the phenomenon in which the solder paste S adheres to the stencil mask 10 because the solder paste S generally has a grain size from approximately 20 μm to approximately 40 μm, as described above.

Although the coating layers 11, 12, and 31 are formed of a DLC film in the illustrated embodiment, they are not limited thereto. The coating layers 11, 12, and 31 may be made of various materials to which the solder paste S does not easily adhere.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A solder paste printing stencil apparatus comprising:
a stencil mask having a plate shape,
wherein the stencil mask is made of fine stainless steel grains.

2. The solder paste printing stencil apparatus according to claim 1, wherein the fine stainless steel grains have a grain size of 5 μm or less.

3. The solder paste printing stencil apparatus according to claim 1, further comprising:
a coating layer to suppress a phenomenon in which a solder paste adheres to the stencil mask.

4. The solder paste printing stencil apparatus according to claim 3, wherein the coating layer comprises a diamond-like carbon film.

5. The solder paste printing stencil apparatus according to claim 3, further comprising:
an opening formed through the stencil mask to coat the solder paste on a printed circuit board,
wherein the coating layer is formed on an inner surface of the opening.

6. The solder paste printing stencil apparatus according to claim 3, wherein the coating layer is formed on a surface of the stencil mask to contact a printed circuit board, on which the solder paste is coated.

7. The solder paste printing stencil apparatus according to claim 3, further comprising:
a squeegee to move the solder paste on a surface of the stencil mask opposing a surface of the stencil mask to contact a printed circuit board, on which the solder paste is coated,
wherein the coating layer is formed on an outer surface of the squeegee.

8. A system to print solder paste comprising:
a stencil mask; and
a squeegee to move the solder paste on a surface of the stencil mask,
wherein the stencil mask and the squeegee comprise grains of material having a grain size less than the grain size of the solder paste.

9. The system to print solder paste according to claim 8, wherein at least one of the stencil mask and the squeegee comprises grains of material having a grain size of 5 μm or less.

10. The system to print solder paste according to claim 8, wherein at least one of the stencil mask grains of material and the squeegee grains of material comprise stainless steel grains.

11. The system to print solder paste according to claim 8, further comprising a coating layer formed on at least one of
an inner surface of an opening formed through the stencil mask,
a surface of the stencil mask that makes contact with the material the solder paste is printed to,
and an outer surface of the squeegee.

12. The system to print solder paste according to claim 11, wherein the coating layer comprises a diamond-like carbon film.

13. The system to print solder paste according to claim 11, wherein the coating layer is formed after the respective surface has been subjected to a sanding process and an electrolytic polishing process.

14. A method of decreasing the adhesion of solder paste to a surface of a material, the method comprising:
forming a surface on the material comprising grains of material having a grain size less than the grain size of the solder paste.

15. The method according to claim 14, wherein the surface material comprises grains of material having a grain size of 5 μm or less.

16. The method according to claim 14, wherein the surface material comprises stainless steel grains.

17. The method according to claim 14, wherein forming the surface further comprises subjecting the surface to a sanding process and an electrolytic polishing process.

18. The method according to claim 17, wherein forming the surface further comprises coating the surface with a coating layer that resists adhesion of the solder paste.

19. The method according to claim 18, wherein the coating layer comprises a diamond-like carbon film.
